(19) United States
(12) Patent Application Publication
(10) Pub. No.: US 2017/0197371 A1
(43) Pub. Date: Jul. 13, 2017

(54) METHOD AND APPARATUS FOR MAKING A COMPOSITE

(71) Applicants: University of Massachusetts, Boston, MA (US); Aurora Flight Sciences Corporation, Manassas, VA (US)

(72) Inventors: Konstantine Fetfatsidis, Tewksbury, MA (US); Christopher John Hansen, Lowell, MA (US); Bradford Olson, Beverly, MA (US); Richard Poillucci, Topsfield, MA (US); Andrew Burke, Carlisle, MA (US)

(21) Appl. No.: 15/403,836

(22) Filed: Jan. 11, 2017

Related U.S. Application Data
(60) Provisional application No. 62/277,396, filed on Jan. 11, 2016.

(51) Int. Cl. B29C 70/38; B29C 67/00; B33Y 40/00; B33Y 10/00; B33Y 30/00; B33Y 50/02; B29C 70/34; B29C 70/54

(52) U.S. Cl. CPC B29C 70/382; B29C 70/34; B29C 67/0092; B29C 70/543; B29C 67/0088; B33Y 10/00; B33Y 30/00; B33Y 50/02; B33Y 40/00; B29K 2105/0872

(57) ABSTRACT

Various embodiments disclosed relate to methods and apparatuses for forming composites. In various embodiments, the present invention provides a method of making a composite. The method can include placing a resin-impregnated fiber on a tooling surface. The method can include at least partially curing the resin-impregnated fiber. The method can also include placing a material in contact with the resin-impregnated fiber, to provide a composite.

### CROSS-REFERENCE TO RELATED APPLICATION

This application claims the benefit of priority to U.S. Provisional Patent Application Ser. No. 62/277,396 filed Jan. 11, 2016, the disclosure of which is incorporated herein in its entirety by reference.

### BACKGROUND

Many industries wish to incorporate multifunctionality into composite structures, including electromagnetic effects, lightning-strike protection, acoustic or vibration damping, erosion resistance, self-healing, improved thermal conductivity or thermal management, electrical transmission or sensing, and flammability improvements. Often the trade-offs inherent between the structural function of the composite structure and the added multifunctionality would benefit from spatially targeted inclusion of functional features. However, no method exists for spatial targeting of multifunctionality within composite structures produced using industrially relevant processes, such as automated fiber placement, automated tape placement, and automated tape layup.

Microvascular approaches have been demonstrated at laboratory scales but there is no method to manufacture large microvascular structures in an efficient, economical manner. Recent attempts to incorporate microvascular channels into composites have involved weaving sacrificial filaments through woven preforms. However, this weaving is limited to shorter continuous filaments in a woven fabric format consisting of orthogonal directions directed by the woven preform.

### SUMMARY OF THE INVENTION

In various embodiments, the present invention provides a method of making a composite. The method includes placing a resin-impregnated fiber on a tooling surface. The method includes at least partially curing the resin-impregnated fiber. The method also includes placing a material in contact with the resin-impregnated fiber, to provide the composite.

In various embodiments, the present invention provides a method of making a composite. The method includes placing a web, tow, or tape of resin-impregnated fibers on a tooling surface using an automated fiber placement machine. The method includes at least partially curing the resin-impregnated fibers. The method also includes placing a material in contact with the resin-impregnated fibers using a 3D-printer that is affixed to the automated fiber placement machine, to provide a composite.

In various embodiments, the present invention provides a method of making a composite. The method includes placing a precursor composite material including a resin-impregnated fiber and a material on a tooling surface. The method also includes at least partially curing the resin-impregnated fiber, to provide a composite.

In various embodiments, the present invention provides a method of making a composite. The method includes placing a resin-impregnated fiber on a tooling surface with an automated fiber placement machine. The method also includes placing a material in contact with the resin-impregnated fiber using a 3D-printer that is affixed to the automated fiber placement machine, to form a composite.

In various embodiments, the present invention provides an apparatus including an automated fiber placement machine configured to place a precursor composite material including a resin-impregnated fiber and a material on a tooling surface via a deposition head, and to at least partially cure the precursor composite to form a composite on the tooling surface. The material can be a sacrificial material.

In various embodiments, the present invention provides an apparatus including an automated fiber placement machine configured to place a resin-impregnated fiber on a tooling surface via a deposition head. The apparatus also includes a 3D-printer affixed to the automated fiber placement machine that is configured to place a material in contact with the resin-impregnated fiber, to form a composite.

Various embodiments of the present invention provide certain advantages over other methods and apparatuses for forming composites, at least some of which are unexpected. In some embodiments, the present invention provides a method and apparatus for forming microvascular composites that can be used to form large composites more efficiently than other methods and apparatus. In some embodiments, the present invention provides a method and apparatus for forming microvascular composites that has reduced or eliminated need for toxic or expensive chemicals, as compared to other methods and apparatuses.

In various embodiments, the present invention provides an apparatus that can 3D-print a wide variety of materials during an automated fiber placement of resin-impregnated fibers, such as sacrificial materials, magnetic materials, optical materials, and the like.

In various embodiments, the present invention can deposit arbitrary design shapes on the surface without regard to the dimensions or direction of the precursor composite material, the sacrificial material, or the material being 3D-printed. In various embodiments, the present invention can deposit arbitrary design dimensions (e.g., the feature size itself changes to be wider and/or thicker, or narrower and/or thinner) without regard to the dimensions or direction of the precursor composite material, the sacrificial material, or the material being 3D-printed. In various embodiments, the present invention can deposit discontinuous precursor composite material, sacrificial material, or the material being 3D-printed. In various embodiments, the present invention provides an ability to include features on complex 3D planes that could not be transferred from a 2D film/sheet, in which case the film might wrinkle or otherwise poorly conform to the 3D plane. In various embodiments, the present invention provides an ability to change the precursor composite material, the sacrificial material, or the material being 3D-printed rapidly both between parts (e.g., by switching the material) or within a part fabrication (e.g., by having a nozzle that can switch materials, or by having multiple deposition heads that can turn on and off). In various embodiments, the present invention can be used to fill in gaps in a structure with precursor composite material, the sacrificial material, or the material being 3D-printed, such as in automated fiber placement where making drastic turns or having starts/stops to the tows can create gaps and/or overlaps that damage the structure. In various embodiments, the present invention can be used to place fiducial markers within the structure which can be used for alignment, such as for non-destructive evaluation/inspection (NDE/NDI).

### BRIEF DESCRIPTION OF THE FIGURES

The drawings illustrate generally, by way of example, but not by way of limitation, various embodiments discussed in the present document.

FIG. 1 illustrates a spool of polylactic acid (PLA) fiber, in accordance with various embodiments.

FIG. 2 illustrates an apparatus for joining together carbon fiber prepreg and sacrificial fiber, in accordance with various embodiments.

FIG. 3 illustrates a spool of carbon fiber prepreg and sacrificial fiber, in accordance with various embodiments.

FIG. 4 illustrates the mandrel and deposition head of an automated fiber placement (AFP) machine, in accordance with various embodiments.

FIG. 5 illustrates a spool being placed on an AFP machine, in accordance with various embodiments.

FIG. 6 illustrates a carbon fiber prepreg tape with sacrificial fiber being fed through the deposition head of an automated fiber placement machine, in accordance with various embodiments.

FIG. 7 illustrates a computer-aided design file, which is transformed into physical features via fused filament fabrication (e.g., 3D-printing), in accordance with various embodiments.

FIG. 8 illustrates 3D-printing of PLA sacrificial material onto carbon fiber prepreg slit tape, in accordance with various embodiments.

FIG. 9 illustrates carbon fiber prepreg bonded together with 3D-printed polylactic acid, in accordance with various embodiments.

FIG. 10 illustrates double cantilever beam strength testing of carbon fiber prepreg bonded together with 3D-printed polylactic acid, in accordance with various embodiments.

FIG. 11 illustrates a cross section of a 3-D printed polylactic acid channel in a carbon fiber prepreg composite, in accordance with various embodiments.

FIG. 12 illustrates a partially evacuated 3-D printed polylactic acid channel in a carbon fiber prepreg composite, in accordance with various embodiments.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. A comma can be used as a delimiter or digit group separator to the left or right of a decimal mark; for example, “0.0001” is equivalent to “0.0001.” All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “organic group” as used herein refers to any carbon-containing functional group. Examples can include an oxygen-containing group such as an alkoxy group, aryloxy group, aralkyloxy group, oxo(carbonyl) group; a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀)hydrocarbyl, wherein R can be hydrogen (in examples that include other carbon atoms) or a carbon-based moiety, and wherein the carbon-based moiety can be substituted or unsubstituted.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbons or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “acyl” as used herein refers to a group containing a carbonyl moiety wherein the group is bonded via the carbonyl carbon atom. The carbonyl carbon atom is also bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. In the special case wherein the carbonyl carbon atom is bonded to a hydrogen, the group is a “formyl” group, an acyl group as the term is defined herein. An acyl group can include 0 to about 12-20 or 12-40 additional carbon atoms bonded to the carbonyl group. An acyl group can include double or triple bonds within the meaning herein. An acryloyl group is an example of an acyl group. An acyl group can also include heteroatoms within the meaning here. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “aryl” as used herein refers to cyclic aromatic hydrocarbons that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, 2-, 3-, 4-, 5-, or 6-substituted phenyl or 2-8 substituted naphthyl groups, which can be substituted with carbon or non-carbon groups such as those listed herein.

The term “heterocyclyl” as used herein refers to aromatic and non-aromatic ring compounds containing three or more ring members, of which one or more is a heteroatom such as, but not limited to, N, O, and S.

The terms “halo,” “halogen,” or “halide” group, as used herein, by themselves or as part of another substituent, mean, unless otherwise stated, a fluorine, chlorine, bromine, or iodine atom.

The term “haloalkyl” group, as used herein, includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The term “UV light” as used herein refers to ultraviolet light, which is electromagnetic radiation with a wavelength of about 10 nm to about 400 nm.

The term “cure” as used herein refers to exposing to radiation in any form, heating, or allowing to undergo a physical or chemical reaction that results in hardening or an increase in viscosity.

The term “solvent” as used herein refers to a liquid that can dissolve a solid, liquid, or gas. Nonlimiting examples of solvents are silicones, organic compounds, water, alcohols, ionic liquids, and supercritical fluids.

As used herein, the term “polymer” refers to a molecule having at least one repeating unit and can include copolymers.

The polymers described herein can terminate in any suitable way. In some embodiments, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

As used herein, the term “3D-printing” refers to any type of additive manufacturing that can form a 3D object using a 3D-printing deposition head. 3D-Printing can include extrusion deposition wherein material is extruded and then hardened, such as fused deposition modeling (FDM), fused filament fabrication (FFF), robocasting, or direct ink writing (DIW) (e.g., using gelled or paste inks). Extrusion deposition can include extruding a flowable material that does not need to be heated to be extruded, or extruding a material that needs to be heated to be extruded (e.g., using a heated nozzle). 3D-Printing can include binding of granular materials, wherein granular materials are laid down and subsequently bound together, such as selective laser sintering (SLS), selective laser melting (SLM), and electron beam melting (EBM), and inkjet 3D printing (print a layer of material followed by a layer of binder). 3D-Printing can include lamination, wherein thin layers of material are laid down and laminated together. 3D-printing can include inkjet printing, wherein a material is printed from an inkjet deposition head and cured (e.g., via cooling or crosslinking). 3D-printing can include aerosol printing, wherein a material is printed from an aerosol jet deposition head.

As used herein, the term “3D-printer” refers to any suitable apparatus that can carry out 3D-printing as described herein, which includes at least a 3D-printing deposition head, and can optionally also include mechanical features that move the 3D-printing deposition head along one or more various axis. In some embodiments, a 3D-printer is attached to an automated fiber machine, such that the automated fiber machine can move the 3D-printing deposition head along the desired one or more axis, and the attached 3D-printer does not include any independent mechanical features that move the 3D-printing deposition head independently of the automated fiber machine deposition head.

### Method of Making a Composite Including Placing a Material on a Resin-Impregnated Fiber.

In various embodiments, the present invention provides a method of making a composite. The method can include placing a resin-impregnated fiber on a tooling surface. The method can include at least partially curing the resin-impregnated fiber. The method can also include placing a material in contact with the resin-impregnated fiber, to provide a composite. Various embodiments provide a composite made by the method, such as an aerospace component (e.g., commercial or military), wind energy component (e.g., wind turbine blades), automotive component, construction component (e.g., building or bridge), or a pressure vessel (e.g., habitable pressure vessel).

The placing of the resin-impregnated fiber and the placing of the material can occur in any order with respect to one another. In some embodiments, the resin-impregnated fiber is placed on the tooling surface before the material is placed in contact with the resin-impregnated fiber. In some embodiments, the method further includes placing the material on the tooling surface prior to placing the resin-impregnated fiber on the tooling surface (e.g., indirectly on the tooling surface, directly on the material), wherein placing the material in contact with the resin-impregnated fiber includes the placing of the resin impregnated fiber on the tooling surface.

The material can be any suitable material that can be placed in contact with the resin-impregnated fiber, such as any suitable material that can be 3D-printed. For example, the material can be poly(lactic acid), acrylonitrile butadiene styrene (ABS), poly ether ether ketone (PEEK), poly ether ketone ketone (PEKK), polyimide, polyetherimide (PEI), polyphenylsulfone (PPS), thermoplastic polyurethanes (TPU), polycaprolactone, polypropylene, polyethylene, or combinations thereof; pastes such as colloidal silica, alumina, titania, barium strontium titanate, silver, copper, or combinations thereof, such as in aqueous or organic solvent suspension with or without binders to create a viscoelastic ink; materials suitable for inkjet printing, such as silver or copper precursors, UV-curable polyurethanes, other polymers, a combination thereof; and combinations thereof. The material can be a sacrificial material, such as a sacrificial fiber.

The sacrificial material can be any suitable sacrificial material, such that it can be removed (e.g., sacrificed) after formation of the composite. The sacrificial material can be a sacrificial fiber. The method can be a method of making a cavitated composite (e.g., a microvascular composite), that includes at least partially sacrificing the sacrificial material, to provide the cavitated composite. Sacrificing the sacrificial material can include exposing the composite material to at least one of heat, acid, base, and solvent, such that at least some of the sacrificial material degrades or dissolves. The method can include removing at least some of the degraded or dissolved sacrificial material, to form a cavitated composite. Various embodiments provide a cavitated composite made by the method, such as an aerospace component (e.g., commercial or military), wind energy component (e.g., wind turbine blades), automotive component, construction component (e.g., building or bridge), or a pressure vessel (e.g., habitable pressure vessel).

The method can include placing a resin-impregnated fiber on a tooling surface. The tooling surface can have any suitable shape, such as the desired shape of the final composite. Placing the resin-impregnated fiber on the tooling surface can include directly placing the resin-impregnated fiber on the tooling surface or placing the resin-impregnated fiber on another material on the tooling surface, such as one or more other fibers (e.g., resin-impregnated fibers that have been at least partially cured), or such as one or more placed materials (e.g., placed during performance of the method or otherwise), such as sacrificial materials or other materials. The resin-impregnated fiber can be placed on the tooling surface in any suitable way. Placing the resin-impregnated fiber on the tooling surface can include unrolling the resin-impregnated fiber from a spool. Placing the resin-impregnated fiber on the tooling surface can include unrolling the resin-impregnated fiber from a spool on an automated fiber placement machine (e.g., on a mandrel thereof) and placing the resin-impregnated fiber on the tooling surface using a deposition head of the automated fiber placement machine. Herein the term “automated fiber placement machine” can include an automated tape placement machine or an automated tape layup machine. The placing the resin-impregnated fiber on the tooling surface can include compressing the resin-impregnated fiber against the tooling surface (e.g., using a roller or other tool on the deposition head of the automated fiber placement machine). Placing the resin-impregnated fiber on the tooling surface can include placing a plurality of resin-impregnated fibers on the tooling surface, such as in the form of a web, a tow, or a tape.

The method can include heating the resin-impregnated fiber. In some embodiments, the method is free of heating the resin-impregnated fiber (e.g., the resin-impregnated fiber can have tackiness without heating). The heating can be any suitable heating, such that the resin-impregnated fiber increases in temperature. The heating can be sufficient to at least partially melt the resin in the resin-impregnated fiber or otherwise activate the resin to cure. The heating can be sufficient to impact tackiness to the resin-impregnated fiber. The heating can include heating to about 30° C. to about 500° C., about 50° C. to about 500° C., or about 30° C. or less, or less than, equal to, or more than about 40° C., 50, 60, 70, 80, 90, 100, 105, 110, 115, 120, 125, 130, 135, 140, 145, 150, 155, 160, 165, 170, 175, 180, 185, 190, 195, 200, 210, 220, 230, 240, 250, 260, 280, 300, 325, 350, 375, 400, 450, 500, 600, 700, 800, 900, 1,000, or about 1,100° C. or more. The heating can be performed by the deposition head of an automated fiber placement machine, such as via an IR heater, a laser heater, or a torch heater. The heating can be performed at any suitable time with respect to the placing of the resin-impregnated fiber on the tooling surface, such as at least partially prior to, during, or after placing the resin-impregnated fiber on the tooling surface, or a combination thereof.

The method can include at least partially curing the resin-impregnated fiber. The curing can be any suitable curing that results in a hardening of the resin-impregnated fiber (which is optionally heated), such as cooling to harden the material (e.g., with a heated thermosplastic resin), crosslinking, polymerizing, thermosetting, or a combination thereof. The curing of the resin-impregnated fiber can occur during or after the placing of the resin-impregnated fiber on the tooling surface. The curing of the resin-impregnated fiber can occur at any suitable time with respect to the placing of the material, such as before, during, after, or a combination thereof.

The method can also include placing a material in contact with the resin-impregnated fiber, to provide a composite. The placing can be any suitable placing, such as extruding, spinning, printing, or a combination thereof. Placing the material in contact with the resin-impregnated fiber can include arranging the material in contact with the resin-impregnated fiber, such as in a pre-determined (e.g., woven, 2D-pattern, or 3D-pattern) or random pattern. The placing of the material in contact with the resin-impregnated fiber can include 3D-printing the material in contact with (e.g., on) the resin-impregnated fiber (e.g., fused filament fabrication, wherein the material is optionally heated to flow the material out of the nozzle, applied to a surface, and allowed to harden). The placing of the material in contact with the resin-impregnated fiber can include 3D-printing the material onto a film or other substrate and transferring the 3D-printed material onto the resin-impregnated fiber. In some embodiments, the placing of the resin-impregnated fiber on the tooling surface and the placing of the material in contact with the resin-impregnated fiber can be performed using the same machine. The placing of the resin-impregnated fiber on the tooling surface and the placing of the material in contact with the resin-impregnated fiber can be performed using the same automatic fiber placement machine. The placing of the resin-impregnated fiber on the tooling surface can be performed by an automatic fiber placement machine, and the placing of the material in contact with the resin-impregnated fiber can be performed by 3D-printing using a 3D printer that is affixed to the automatic fiber placement machine.

The method can include placing a second resin-impregnated fiber on top of the material, such that the material is between the resin-impregnated fiber and the second resin-impregnated fiber.

### Method of Forming a Composite Including Placing a Precursor Composite Material.

Various embodiments provide a method of making a composite. The method can include placing a precursor composite material including a resin-impregnated fiber and a material on a tooling surface. The method can also include at least partially curing the resin-impregnated fiber, to provide a composite.

The material can be any suitable material that can be placed in contact with the resin-impregnated fiber, such as any suitable material that can be placed via the deposition head of an automated fiber placement machine. For example, the material can be poly(lactic acid), acrylonitrile butadiene styrene (ABS), poly ether ether ketone (PEEK), poly ether ketone ketone (PEKK), polyimide, polyetherimide (PEI), polyphenylsulfone (PPS), thermoplastic polyurethanes (TPU), polycaprolactone, polypropylene, polyethylene, or combinations thereof; pastes such as colloidal silica, alumina, titania, barium strontium titanate, silver, copper, or combinations thereof, such as in aqueous or organic solvent suspension with or without binders to create a viscoelastic ink; materials suitable for inkjet printing, such as silver or copper precursors, UV-curable polyurethanes, other polymers, a combination thereof; and combinations thereof. The material can be a sacrificial material, such as a sacrificial fiber.

The sacrificial material can be any suitable sacrificial material, such that it can be removed (e.g., sacrificed) after formation of the composite. The sacrificial material can be a sacrificial fiber. The method can be a method of making a cavitated composite (e.g., a microvascular composite), that includes at least partially sacrificing the sacrificial material, to provide the cavitated composite. Sacrificing the sacrificial material can include exposing the composite material to at least one of heat, acid, base, and solvent, such that at least some of the sacrificial material degrades or dissolves. The method can include removing at least some of the degraded or dissolved sacrificial material, to form a cavitated composite. Various embodiments provide a cavitated composite made by the method, such as an aerospace component (e.g., commercial or military), wind energy component (e.g., wind turbine blades), automotive component, construction component (e.g., building or bridge), or a pressure vessel (e.g., habitable pressure vessel).

The method can include placing a precursor composite material including a resin-impregnated fiber and a material on a tooling surface. Placing the precursor composite material on the tooling surface can include directly placing the precursor composite material on the tooling surface or placing the precursor composite material on another material on the tooling surface, such as one or more other fibers (e.g., resin-impregnated fibers that have been at least partially cured). The material can be embedded on the resin impregnated fiber, such that the material is attached to the resin impregnated fiber, such as attached to a surface thereof, or bonded together with such as via the resin. If the resin-impregnated fiber is part of a web, tow, or tape, the material can be attached to a surface of the web, tow, or tape, or can be one or more of a plurality of fibers that form the web, tow, or tape. Placing the precursor composite material on the tooling surface can include placing a web, tow, or tape of resin-impregnated fibers including the resin-impregnated fiber on the tooling surface. Placing the precursor composite material on the tooling surface can include unrolling the precursor composite material from a spool (e.g., a spool on a mandrel of an automated fiber placement machine). The placing the precursor composite material on the tooling surface can include unrolling the precursor composite material from a spool on an automated fiber placement machine. Placing the precursor composite material on the tooling surface can include compressing the precursor composite material against the tooling surface.

The method can further include placing a second resin-impregnated fiber on top of the material, such that the material is between the resin-impregnated fiber and the second resin-impregnated fiber.

The method can include heating the precursor composite material. In some embodiments, the method is free of heating of the precursor composite material. The heating can be any suitable heating, such that the resin-impregnated fiber increases in temperature. The heating can be sufficient to at least partially melt the resin in the resin-impregnated fiber or otherwise activate the resin to cure. The heating can be sufficient to impact tackiness to the resin-impregnated fiber and to the precursor composite including the resin-impregnated fiber. The heating can include heating to about 30° C. to about 500° C., about 50° C. to about 500° C., or about 30° C. or less, or less than, equal to, or more than about 40° C., 50, 60, 70, 80, 90, 100, 105, 110, 115, 120, 125, 130, 135, 140, 145, 150, 155, 160, 165, 170, 175, 180, 185, 190, 195, 200, 210, 220, 230, 240, 250, 260, 280, 300, 325, 350, 375, 400, 450, 500, 600, 700, 800, 900, 1,000, or about 1,100° C. or more. The heating can be performed by the deposition head of an automated fiber placement machine, such as via an IR heater, a laser heater, or a torch heater. The heating can be performed at any suitable time with respect to the placing of the precursor composite on the tooling surface, such as at least partially prior to, during, or after placing the precursor composite on the tooling surface, or a combination thereof.

The method can also include at least partially curing the resin-impregnated fiber, to provide a composite. The curing can be any suitable curing that results in a hardening of the resin-impregnated fiber (which is optionally heated), such as cooling to harden the material (e.g., with a heated thermosplastic resin), crosslinking, polymerizing, thermosetting, or a combination thereof. The curing of the resin-impregnated fiber can occur during or after the placing of the resin-impregnated fiber on the tooling surface.

### Resin-Impregnated Fiber.

The resin-impregnated fiber can be any suitable resin-impregnated fiber. The resin-impregnated fiber includes a fiber and a resin that contacts the fiber. The resin can substantially coat the fiber. The resin-impregnated fiber can be part of a plurality of fibers coated by the resin, such as a web, tow, or tape of resin-impregnated fibers.

The fiber can be any suitable fiber. The fibers can be non-degradable or non-dissolvable, such that under conditions wherein a sacrificial fiber degrades or dissolves the fiber of the resin-impregnated fiber experiences little to no degradation or dissolution. The fiber of the resin-impregnated fiber can include an inorganic or an organic material, such as carbon (e.g., carbons fibers such as HexTow® IM7 carbon fiber or HexTow® AS4 carbon fiber, or graphite such as Thornal® P25 or Modmor, optionally including resins such as Cycom® 5320-1 or HexPly® 8552), ceramic, metal oxide (e.g., titanium oxide, zirconium oxide, or aluminum oxide), silica, glass, metal, polymer (e.g., polyester, nylon, rayon, polyaramid), or a combination thereof. The fiber can be a carbon fiber.

The resin can be any suitable resin, such that the resin can cured to harden the resin (e.g., to bond the resin-impregnated fiber to the tooling surface or to another fiber thereon). In some embodiments, the resin is suitable such that the resin can be cured, with optional heating prior to or during the curing. The resin can include a curable composition, e.g., a thermoset composition, a thermoplastic composition (e.g., having a higher melting point than the degradation temperature of the degradable material), a polymerizable composition, a crosslinkable composition, or a combination thereof. Any suitable proportion of the resin can be the curable composition, such as about 10 wt % to about 100 wt % of the resin, or about 50 wt % to about 99.999%, or about 10 wt % or less, or less than, equal to, or more than about 15 wt %, 20, 25, 30, 35, 40, 45, 50, 55, 60, 65, 70, 75, 80, 85, 90, 91, 92, 93, 94, 95, 96, 97, 98, 99, 99.5, 99.9, 99.99, or about 99.999 wt % or more of the resin.

The curable composition or the cured product thereof (e.g., the curable composition can include monomers or partially polymerized monomers that can polymerize to form the cured product, and can optionally include any suitable catalyst) can include a polyamide such as nylon; a polyester such as poly(ethylene terephthalate) or polycaprolactone; a polycarbonate; a polyether; an epoxy polymer; an epoxy vinyl ester polymer; a polyimide such as polypyromellitimide; a phenol-formaldehyde polymer; an amineformaldehyde polymer such as a melamine polymer; a polysulfone; a poly(acrylonitrile-butadiene-styrene) (ABS); a polyurethane; a polyolefin such as polyethylene, polystyrene, polyacrylonitrile, a polyvinyl, polyvinyl chloride, or poly(dicyclopentadiene); a polyacrylate such as poly(ethyl acrylate); a poly(alkylacrylate) such as poly(methyl methacrylate); a polysilane such as poly(carborane-silane); a cyanate resin system; a polyphosphazene; and combinations thereof.

The curable composition can include an elastomer, such as an elastomeric polymer, an elastomeric copolymer, an elastomeric block copolymer, an elastomeric polymer blend, and combinations thereof. Examples of elastomer polymers can include polyolefins, polysiloxanes such as poly(dimethylsiloxane) (PDMS), polychloroprene, and polysulfides; examples of copolymer elastomers may include polyolefin copolymers and fluorocarbon elastomers; examples of block copolymer elastomers may include acrylonitrile block copolymers, polystyrene block copolymers, polyolefin block copolymers, polyester block copolymers, polyamide block copolymers, polyurethane block copolymers; and examples of polymer blend elastomers include mixtures of an elastomer with another polymer; and combinations thereof. The curable composition can include a mixture of these polymers, including copolymers that include repeating units of two or more of these polymers, and/or including blends of two or more of these polymers.

The resin can include other ingredients in addition to the curable composition. For example, the resin can include one or more catalysts, acid generators, solvents, crosslinkers, particulate fillers, stabilizers, antioxidants, flame retardants, plasticizers, colorants, dyes, fragrances, or adhesion promoters. An adhesion promoter is a substance that increases the adhesion between two materials, such as the adhesion between two polymers, or between a resin or a cured product thereof and a material such as a sacrificial material or other material.

The resin impregnated fiber can include or can be carbon fiber prepreg (e.g., a plurality of resin-impregnated fibers in the form of a web, tow, or tape).

Sacrificial Material.

The sacrificial material can have any suitable size and shape. In some embodiments, the sacrificial material can be any suitable shape, such as planar, spherical, irregular, or cylindrical (e.g., fibers), and can have any suitable dimensions, such that the sacrificial material can be used as described herein. The fibers can be formed by any suitable method, such as by at least one of extrusion, spinning (e.g., solvent spinning), and printing (e.g., three-dimensional printing). The fibers can have any suitable dimensions, such as a diameter of about 0.001 μm to about 5 mm, about 50 μm to about 1 mm, or about 0.001 μm or less, or less than, equal to, or more than about 0.005 μm, 0.01, 0.05, 0.1, 0.5, 1, 2, 3, 4, 5, 10, 15, 20, 25, 50, 75, 100, 150, 200, 250, 500, 750 μm, 1 mm, 1.5, 2, 2.5, 3, 3.5, 4, 4.5, or about 5 mm or more, and such as a length of about 1 μm to about 50 km, 1 μm to about 1 km, 1 μm to about 50 m, about 100 μm to about 10 m, or about 1 μm or less, or less than, equal to, or more than about 5 μm, 10, 20, 50, 100, 250, 500 μm, 1 mm, 5, 10, 15, 20, 25, 50, 75, 100, 150, 200, 250, 500, 750 mm, 1 m, 2, 3, 4, 5, 10, 20, 30, 40, 50, 100, 150, 200, 250, 500, 750 m, 1 km, 1.5 km, 2, 3, 4, 5, 10, 15, 20, 30, 40, or about 50 km or more.

The sacrificial material can include any suitable material that can be degraded or dissolved and removed from another material (e.g., degradable or dissolvable material). In various embodiments, the sacrificial material includes one or more polymers that include a repeating unit including a substituted or unsubstituted (C₂-C₂₀)hydrocarbylene and at least one of carbonate, carbamate, thiocarbonate, and thiocarbamate. The substituted or unsubstituted (C₂-C₂₀)hydrocarbylene and the carbonate, carbamate, thiocarbonate, or thiocarbamate can be part of the backbone of the polymer, e.g., non-pendant groups. The polymer can include a repeating unit that is a (C₂-C₅)hydrocarbylene carbonate, e.g., ethylene carbonate, propylene carbonate, butylene carbonate, or pentylene carbonate. The polymer can include a repeating unit that is a substituted or unsubstituted ethylene carbonate, such as substituted with one or more substituted or unsubstituted (C₁-C₁₀)hydrocarbyl groups. The polymer can include a repeating unit that is ethylene carbonate or propylene carbonate (e.g., ethylene carbonate having a methyl group substituted on the ethylene group). In some embodiments the polymer is poly(ethylene carbonate) or poly(propylene carbonate) (e.g., wherein the propylene is bonded at the 1- and 2-positions). In some embodiments, the polymer is a poly(ethylene carbonate) copolymer or a poly(propylene carbonate) copolymer. In some embodiments, the polymer is a poly(ethylene carbonate)-poly(propylene carbonate) copolymer). The polymer can be poly(lactic acid). The sacrificial material can include poly(lactic acid) and a catalyst such as tin(II) oxide.

Any suitable proportion of the sacrificial material can be the degradable material such as a degradable polymer. For example, in some embodiments, degradation and removal of only part of a sacrificial material can be sufficient to generate the desired cavities (e.g., microvascular channels or pores). In various embodiments, about 10 wt % to about 100 wt % of the sacrificial material is the one or more polymers including the repeating unit including a substituted or unsubstituted (C₂-C₂₀)hydrocarbylene and at least one of carbonate, carbamate, thiocarbonate, or about 50 wt % to about 99.9 wt %, or about 75 wt % to about 99.9 wt %, or about 10 wt % or less, or less than, equal to, or more than about 15 wt %, 20, 25, 30, 35, 40, 45, 50, 55, 60, 65, 70, 75, 80, 85, 90, 91, 92, 93, 94, 95, 96, 97, 98, 99, 99.9, 99.99, or about 99.999 wt % or more. The remainder of the sacrificial material can be any suitable one or more components, such as one or more catalysts, acid generators, particulate fillers, stabilizers, antioxidants, flame retardants, plasticizers, colorants, dyes, fragrances, or adhesion promoter.

The sacrificial material can further include a catalyst, such as to catalyze the degradation of the sacrificial material, enabling degradation at lower temperature than possible without the catalyst. The sacrificial material can include one catalyst, or more than one catalyst. The catalyst can be a metal oxalate, such as aluminum oxalate, ammonium niobate(V) oxalate hydrate, ammonium oxalate, antimony oxalate, barium oxalate, beryllium oxalate, bismuth oxalate, cadmium oxalate, calcium oxalate, calcium oxalate hydrate, calcium oxalate monohydrate, cerium oxalate, cesium oxalate, chromium oxalate, cobalt oxalate, cobalt(II) oxalate dihydrate, copper oxalate, dysprosium oxalate, dysprosium(III) oxalate hydrate, erbium oxalate, erbium(III) oxalate hydrate, europium oxalate, gadolinium oxalate, gadolinium(III) oxalate hydrate, holmium oxalate, iron(II) oxalate, iron oxalate, lanthanum oxalate, lead oxalate, lithium oxalate, lutetium oxalate, lutetium oxalate hydrate, magnesium oxalate, molybdenum oxalate, neodymium oxalate, nickel oxalate, nickel(II) oxalate dihydrate, niobium oxalate, palladium oxalate, potassium oxalate anhydrous, potassium oxalate monohydrate, praseodymium oxalate, praseodymium oxalate decahydrate, rubidium oxalate, ruthenium oxalate, samarium oxalate, silver oxalate, sodium oxalate, strontium oxalate, tantalum oxalate, terbium oxalate, thulium oxalate, tin(II) oxalate, titanium oxalate, ytterbium oxalate, yttrium oxalate, zinc oxalate, zirconium oxalate, or a combination thereof. The catalyst can be tin(II) oxalate. The catalyst can be any suitable proportion of the sacrificial material, such as about 0.001 wt % to about 30 wt % of the sacrificial material, about 0.1 wt % to about 10 wt %, about 0.001 wt % or less, or less than, equal to, or more than about 0.005, 0.01, 0.05, 0.1, 0.5, 1, 2, 3, 4, 5, 6, 8, 10, 12, 14, 16, 18, 20, 22, 24, 26, 28, or about 30 wt % or more.

The polymer can have any suitable molecular weight, such as about 100 g/mol to about 10,000,000 g/mol, or about 100 g/mol or less, or less than, equal to, or more than about 200 g/mol, 300, 400, 500, 750, 1,000, 1,500, 2,000, 2,500, 5,000, 10,000, 15,000, 20,000, 25,000, 50,000, 100,000, 200,000, 500,000, 1,000,000, 5,000,000, or about 10,000,000 g/mol or more.

### Degradation or Dissolution and Removal of Sacrificial Material.

The method can include at least partially degrading the sacrificial material (e.g., the degradable or dissolvable material in the sacrificial material) and at least partially removing the degraded or dissolved sacrificial material. The degradation or dissolution can occur in any suitable way, such as by application of at least one of heat, solvent, and chemicals such as acid or another suitable chemical.

In some embodiments, the degrading or dissolution of the sacrificial material can include subjecting the composite material to acid. The acid can be any suitable acid, including mineral acids such as HCl, H₂SO₄, HNO₃, HF, or such as suitable organic acid. The acid can be sufficient to generate a pH of less than 7, such as about −2 or less, or less than, equal to, or greater than about −1.5, −1, −0.5, 0, 0.5, 1, 1.5, 2, 2.5, 3, 3.5, 4, 4.5, 5, 5.5, 6, or about 6.5 or more. The acid can come from any suitable source. The acid can be added to the composite, such as via immersion of the composite in an acidic solution, such that the sacrificial material is exposed to the acid. The acid can be generated from within the composite, such as via use of one or more acid generators, such as one or more photoacid generators or one or more thermolytic acid generators. In some embodiments, and acid generator such as a photoacid generator can affect the curing process of the curable composition, such as by accelerating or enhancing the curing process of the curable composition nearby the sacrificial material. In various embodiments, acceleration or enhancement of the curing process near the sacrificial material can make the composite better retain its shape after degradation of the sacrificial material.

The degradation or dissolution can include subjecting the composite material to base. The base can be any suitable base, such as aqueous solutions of NaOH, KOH, Al(OH)₃, or any combination thereof, optionally including water-miscible organic solvents such as alcohols (e.g., propane-2-ol). The base can be sufficient to generate a pH of greater than 7, such as less than, equal to, or greater than about 8, 9, 10, 11, 12, 13, 14, 15, 16, 17, 18, 19, or about 20 or more. The base can come from any suitable source. The base can be added to the composite, such as via immersion of the composite in a basic solution, such that the sacrificial material is exposed to the base. The base can be generated from within the composite, such as via use of one or more base generators.

The degradation or dissolution can include subjecting the composite material to a solvent. The solvent can be any suitable solvent, such as water, an organic solvent, dichloromethane, tetrahydrofuran, dimethylformamide, glacial acetic acid, methylene chloride, or any combination thereof. The solvent can be added to the composite, such as via immersion of the composite in the solvent, such that the sacrificial material is dissolved.

The degradation or dissolution can include exposing an acid generator to conditions suitable for the acid generator to generate acid, such as suitable amounts of at least heat or light. For example, generating the acid using a photoacid generator can include exposing to suitable amounts of light. In some embodiments, the light can be UV light. The light can be light including 248 nm wavelength light (e.g., for IMPTB). In some embodiments, the thickness of the composite can be sufficient to block light from photoacid generator within the composite; some embodiments of the invention include forming an intermediate layer of curable material and sacrificial material, curing the curable material, subjecting the layer to sufficient light to activate the photoacid generator, and forming a subsequent layer of curable material and sacrificial material. A process including forming multiple layers can include repeating the steps of forming, curing, and activating the photoacid generator until the desired cavitated material is formed.

The removing of the degraded or dissolved sacrificial material can be performed in any suitable way. In some embodiments, a suitable solvent can be used to dissolve or wash away the degraded or dissolved components. In some embodiments, at least one of heat and vacuum can be used to cause the degraded or dissolved components to at least partially vaporize such that they can diffuse out of the composite. The removing can include exposing to a suitable temperature, such as about 50° C. to about 500° C., or about 110° C. to about 130° C., or less than about 200° C., 195, 190° C., or less than 180° C., or about 50° C. or less, or less than, equal to, or more than about 60° C., 70, 80, 90, 100, 105, 110, 115, 120, 125, 130, 135, 140, 145, 150, 155, 160, 165, 170, 175, 180, 185, 190, 195, 200, 210, 220, 230, 240, 250, 260, 280, 300, 325, 350, 375, 400, 450, or about 500° C. or more. In some embodiments, the removing includes exposing to no vacuum (e.g., using ambient pressure). The removing can include exposing to a suitable vacuum, such as about 0.0001 mm Hg to about 750 mm Hg, about 0.0001 mm Hg to about 300 mm Hg, or about 20 mm Hg to about 30 mm Hg, or about 0.0001 mm Hg or less, or less than, equal to, or more than about 0.001 mm Hg, 0.01, 0.1, 1, 2, 3, 4, 5, 6, 8, 10, 12, 14, 16, 18, 20, 22, 24, 26, 28, 30, 40, 50, 60, 70, 80, 90, 100, 150, 200, 250, 300, 350, 400, 450, 500, 550, 600, 650, 700, or about 750 mm Hg or more. The removing can include exposing to the suitable temperature and suitable vacuum for any suitable amount of time, such as less than 1 h, less than 50 minutes, 40, 35, 30, 25, or less than 20 minutes, such as about 1 second or less, or less than, equal to, or more than about 5 seconds, 10, 20, 30, 40, 50 second, 1 minute, 2, 3, 4, 5, 10, 15, 20, 25, 30, 35, 40, 45, 50, 55 minutes, 1 hour, 1.2, 1.4, 1.6, 1.8, 2, 3, 4, 5, 6, 7, 8, 9, 10, 15, 20 h, 1 day, 1.5, 2, 3, 4, 5, 6 days, 1 week, 2 weeks, or about 1 month or more.

### Acid Generator.

In various embodiments, the composite includes an acid generator. The acid generator can be a one or more photoacid generators or one or more thermolytic acid generators. The photoacid generator can be any suitable photoacid generator, such that the method can be performed as described herein. For example, the photoacid generator can be at least one of bis(4-tert-butylphenyl)iodonium perfluoro-1-butanesulfonate, bis(4-tert-butylphenyl)iodonium p-toluenesulfonate, bis(4-tert-butylphenyl)iodonium triflate, boc-methoxyphenyldiphenylsulfonium triflate, (4-bromophenyl)diphenylsulfonium triflate, (tert-butoxycarbonylmethoxynaphthyl)-diphenylsulfonium triflate, (4-tert-butylphenyl)diphenylsulfonium triflate, diphenyliodonium, diphenyliodonium nitrate, diphenyliodonium perfluoro-1-butanesulfonate, diphenyliodonium p-toluenesulfonate, diphenyliodonium triflate, (4-fluorophenyl)diphenylsulfonium triflate, N-hydroxynaphthalimide triflate, N-hydroxy-5-norbornene-2,3-dicarboximide perfluoro-1-butanesulfonate, (4-iodophenyl)diphenylsulfonium triflate, (4-methoxyphenyl)diphenylsulfonium triflate, 2-(4-methoxystyryl)-4,6-bis(trichloromethyl)-1,3,5-triazine, (4-methylphenyl)diphenylsulfonium triflate, (4-methylthiophenyl)methyl phenyl sulfonium triflate, (4-phenoxyphenyl)diphenylsulfonium triflate, (4-phenylthiophenyl)diphenylsulfonium triflate, triarylsulfonium hexafluorophosphate, triphenylsulfonium perfluoro-1-butanesufonate, triphenylsulfonium triflate, tris(4-tert-butylphenyl)sulfonium perfluoro-1-butanesulfonate, and tris(4-tert-butylphenyl)sulfonium triflate. The photoacid generator can be 4-isopropyl-4′-methyldiphenyliodonium tetrakis(pentafluorophenyl)borate (IMTPB). The photoacid generator can be any suitable proportion of the composite, such as about 0.0001 wt % to about 30 wt %, or about 0.1 wt % to about 5 wt %, or about 0.0001 wt % or less, or less than, equal to, or more than about 0.0005 wt %, 0.001, 0.005, 0.01, 0.05, 0.1, 0.5, 1, 2, 3, 4, 5, 6, 8, 10, 12, 14, 16, 18, 20, 22, 24, 26, 28, or about 30 wt % or more.

An acid generator can be placed in the composite in any suitable way. In some embodiments, the acid generator is part of the resin-impregnated fiber. In some embodiments, the photoacid generator is part of the sacrificial material, such as distributed within the material (e.g., via direct mixing with the material that forms the material or via chemical infusion after the material is formed such after extrusion or spinning) or as a coating on the outside of the material.

### Apparatus Configured to Place a Precursor Composite Material Including a Resin-Impregnated Fiber and a Material.

In various embodiments, the present invention provides an apparatus. The apparatus can include an automated fiber placement machine. The automated fiber placement machine can be configured to place a precursor composite including resin-impregnated fiber and a material on a tooling surface via a deposition head. The material can be a sacrificial material or any other material, such as a material described herein. The resin-impregnated fiber can be any suitable resin-impregnated fiber. The automated fiber placement machine can be configured to cure the precursor composite to form a composite on the tooling surface. The automated fiber placement machine can optionally be configured to heat the precursor composite before or during the curing. The precursor composite can be on a spool loaded on a mandrel of the automated fiber placement machine, wherein the spool feeds the precursor composite to the deposition head for placement on the tooling surface.

### Method and Apparatus for 3D-Printing a Material on a Resin-Impregnated Fiber.

In various embodiments, the present invention provides an apparatus. The apparatus can include an automated fiber placement machine configured to place a resin-impregnated fiber on a tooling surface via a deposition head. The apparatus can include a 3D-printer that is configured to place a material in contact with the resin-impregnated fiber, to form a composite. The 3D printer can include one or more printheads (e.g., 1, 2, 3, 4, 5, or more). The 3D-printer can be affixed to the automated fiber placement machine (e.g., affixed to the mandrel, the deposition head, affixed via one an available port that is normally used to integrate other features such as an infrared heater, or affixed to some other part of the machine). The material placed by the 3D-printer can be any suitable material. In some embodiments, the material placed by the 3D-printed can be polymers such as poly(lactic acid), acrylonitrile butadiene styrene (ABS), poly ether ether ketone (PEEK), poly ether ketone ketone (PEKK), polyimide, polyetherimide (PEI), polyphenylsulfone (PPS), thermoplastic polyurethanes (TPU), polycaprolactone, polypropylene, polyethylene, or combinations thereof; pastes such as colloidal silica, alumina, titania, barium strontium titanate, silver, copper, or combinations thereof, such as in aqueous or organic solvent suspension with or without binders to create a viscoelastic ink; materials suitable for inkjet printing, such as silver or copper precursors, UV-curable polyurethanes, other polymers, a combination thereof; and combinations thereof. The material placed by the 3D-printer can be a sacrificial material, such as a sacrificial fiber. In some embodiments, the 3D printing of the material can be controlled via the computer numerically controlled (CNC) programmability of the AFP machine (e.g., the same program that controls the lay-down of resin-impregnated fiber can also controls the lay-down patterns of the 3D-printed material).

In various embodiments, the present invention provides a method of making a composite. The method can include placing a resin-impregnated fiber on a tooling surface with an automated fiber placement machine. The method can include placing a material in contact with the resin-impregnated fiber using a 3D-printer (e.g., a 3D-printing head) that is affixed to the automated fiber placement machine, to form a composite. The material placed by the 3D-printer can be any suitable material. The material placed by the 3D-printer can be a sacrificial material, such as a sacrificial fiber. The method can include simultaneously or sequentially placing the material with the 3D-printer and placing the resin-impregnated fiber on the tooling surface. The method can include placing the resin-impregnated fiber, followed by 3D-printing the material on the resin-impregnated fiber. The method can include placing the material with the 3D-printer first, then placing the resin-impregnated fiber on the 3D-printed material.

3D-Printing of the material can provide design flexibility in terms of the ability to change the dimensions of the 3D-printed material during production of the composite, the ability to start or stop the lay-down of the 3D-printed material independently of whether the resin-impregnated fiber is being applied, and the ability to lay-down 3D-printed material in orientations independent of the orientation of the resin-impregnated fiber.

### EXAMPLES

Various embodiments of the present invention can be better understood by reference to the following Examples which are offered by way of illustration. The present invention is not limited to the Examples given herein.

The carbon fiber prepreg slit tape used in these Examples were 1) HexTow® IM7 carbon fiber with Cycom® 5320-1 out-of-autoclave epoxy resin system (used in Part II), or 2) HexTow® AS4 carbon fiber with HexPly® 8552 autoclave-curve epoxy resin system (used in Part I).

### Part I. Spooling Together of Sacrificial Material and Carbon Fiber Prepreg Slit Tape.

### Example 1-1. Production of PLA Fiber

Purchased Materials.

Polylactic acid (PLA) with the brand name Ingeo® Biopolymere 2003D was received from NatureWorks, LLC (Blair, Nebr.), and is recommended for extrusion by the manufacturer. Additional chemicals purchased were tin (II) oxalate (98 wt % purity, Sigma Aldrich USA), which was used as a catalyst for accelerated PLA decomposition. Furthermore light mineral oil was used as a binder between the PLA pellets and the tin (II) oxalate.

PLA with added tin (II) oxalate as a catalyst was extruded to produce fibers of different diameters. After drying the PLA pellets for at least 2 h at 90° C., the material was stored in a vacuum-sealed bag to prevent exposure to the humidity in the atmosphere. About 24 h before use, the dry PLA pellets were pre-coated with tin (II) oxalate powder by evenly coating the PLA pellets with 1 wt % mineral oil, then adding 3 wt % tin (II) oxalate powder into a container. All ingredients were mixed for several minutes with an IKA mixer (RW20 DS1) fitted with an auger blade prior to extrusion, forming PLA/tin (II) oxalate (3 wt %) fibers with a diameter of approximately 500 microns.

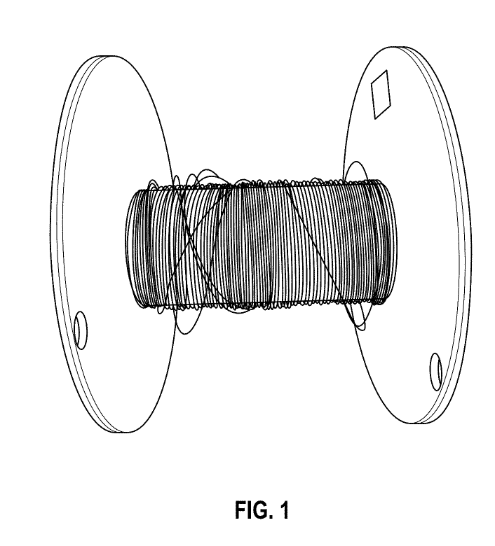

A spool of the PLA fiber is shown in FIG. 1, with a 10 mm scale bar.

### Example 1-2. Spooling of PLA Fiber with Carbon Fiber Prepreg

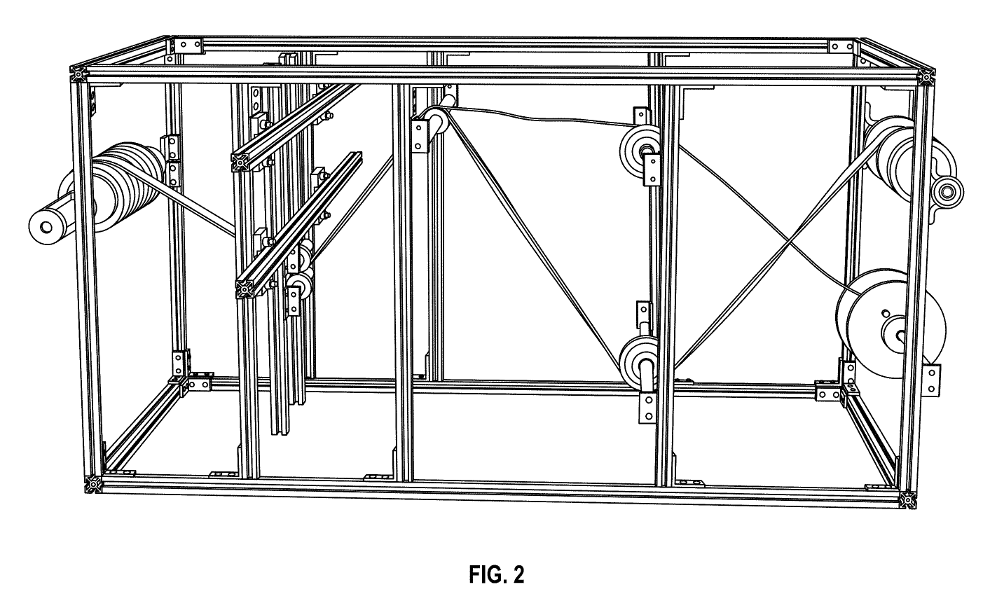

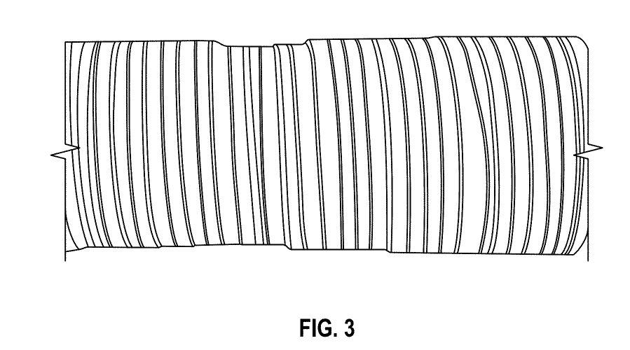

The filament spool from Example 1 and a carbon fiber prepreg were put onto an apparatus that joined them together, as illustrated in FIG. 2. The fiber-filament spool formed is illustrated in FIG. 3. This Example demonstrates that the filament can be fed into a fused filament fabrication machine printhead that then can extrude the thermoplastic as a filament of controllable size onto carbon fiber pre-preg tape as it was being spooled, and that the spooled material can be placed by the automated fiber placement head.

### Example 1-3. Use of Sacrificial Fibers and Carbon Fiber Prepreg Slit Tape in Automated Fiber Placement (AFP) Machine

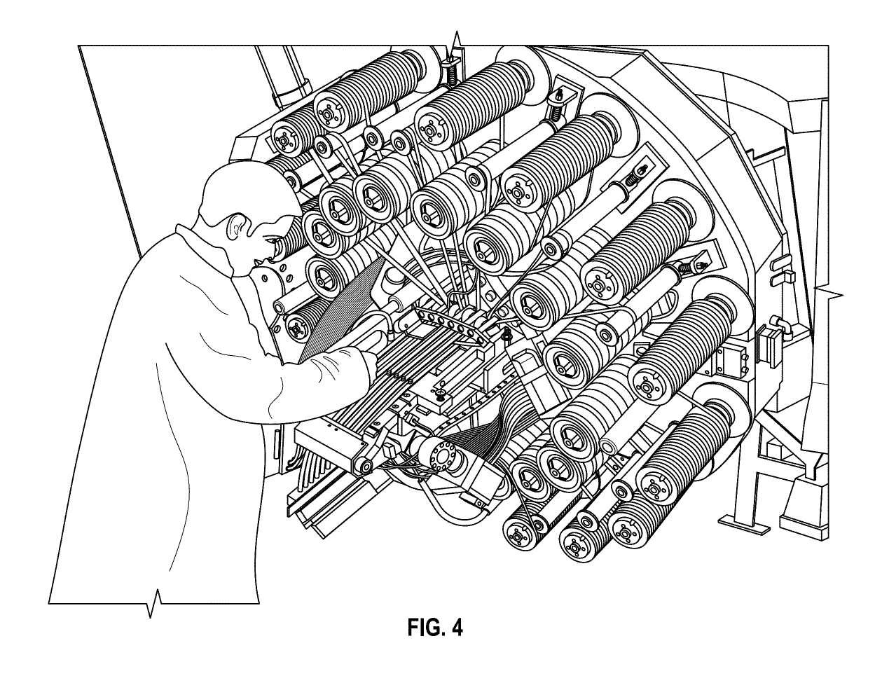

The mandrel and deposition head of the AFP machine is illustrated in FIG. 4.

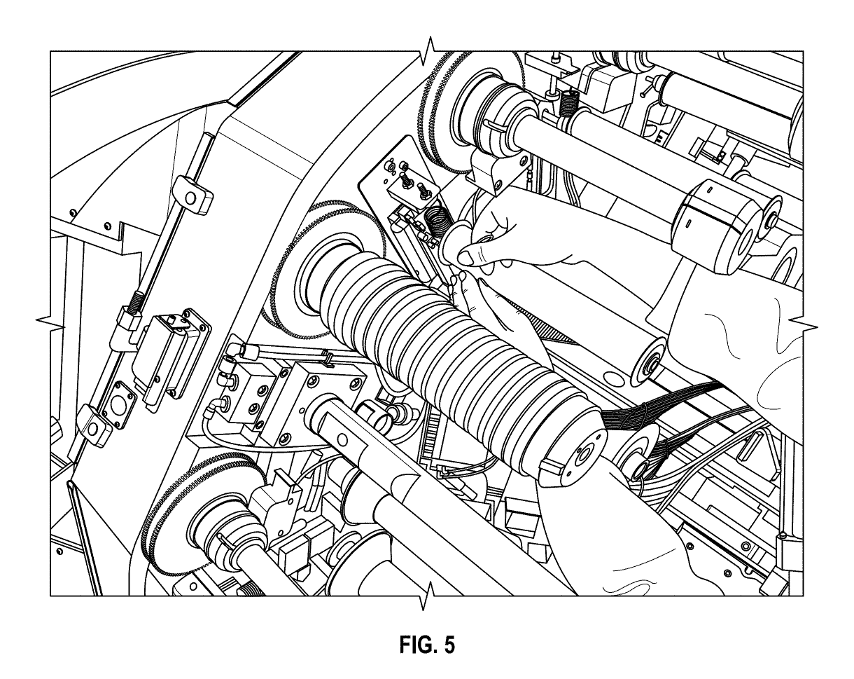

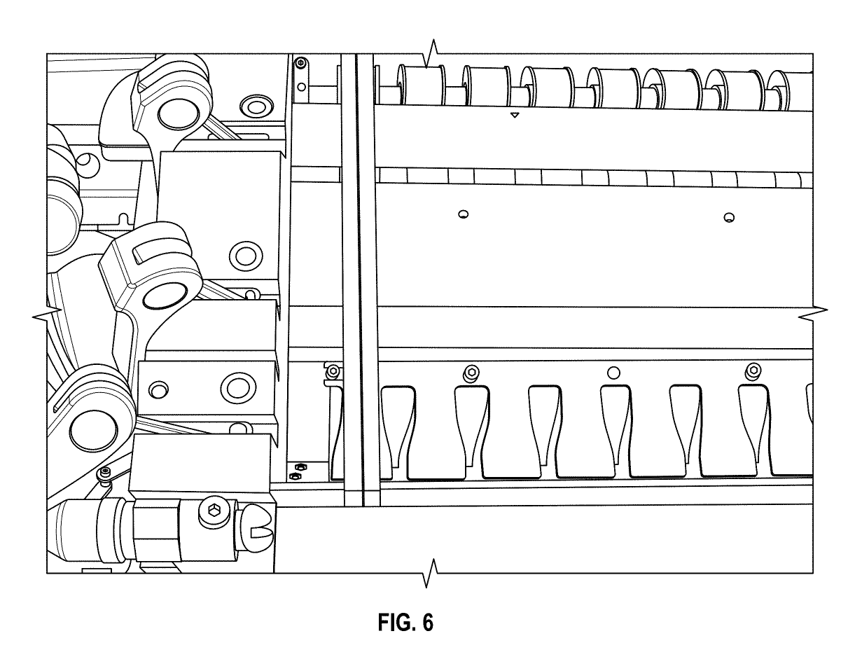

FIG. 5 illustrates the spool from Example 3 being mounted on the AFP machine. FIG. 6 illustrates the combined sacrificial fibers and carbon fiber prepreg slit tape fed through the deposition head. The AFP machine was successfully used to deposit the combined sacrificial fibers and carbon fiber prepreg slit tape onto the tool surface.

### Part II. 3D-Printing of Sacrificial Material.

### Example 2-1. 3D-Printing of Sacrificial Fiber

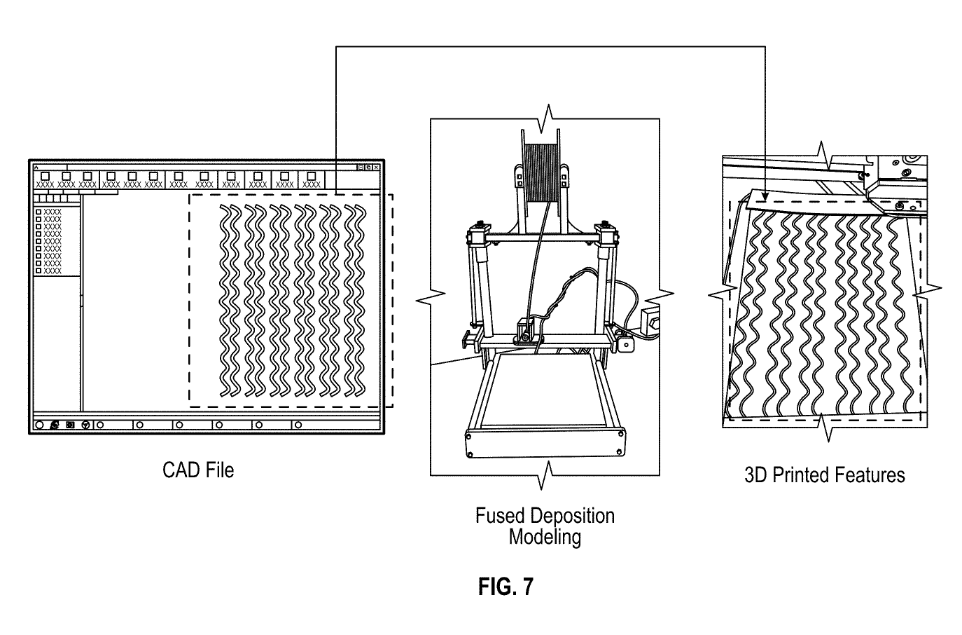

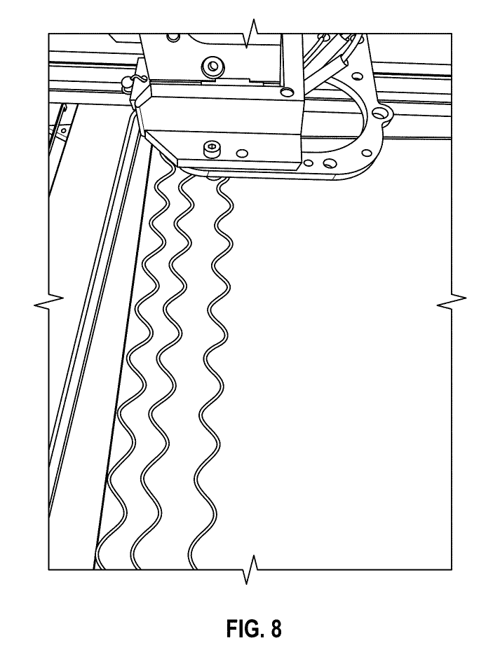

As illustrated in FIG. 7, a computer CAD design file is inputted to the 3-D printer (e.g., fused filament fabrication machine), which then translates the digital instructions into melting instructions for the PLA and motion to deposit it onto the prepreg carbon fiber, which has already been placed onto the substrate (e.g., the tooling surface). Then additional layers of carbon can be added on top if desired. The right-hand image in FIG. 7 shows the final 3-D printed features (in white) on the black background of the carbon fibers. While these carbon fiber tows were placed by hand onto the substrate, there is no important difference in the carbon fiber in this instance. FIG. 8 illustrates the same concept, earlier in the build process, where the area at the top of the picture is the printhead actively depositing the white plastic material. The sacrificial filament showed good adhesion to the prepreg surface even at room temperature conditions, and good adhesion at elevated temperatures (e.g., at temperatures generated by an infrared (IR) heater on a deposition head of an automated fiber placement machine).

### Example 2-2. Analysis of Results

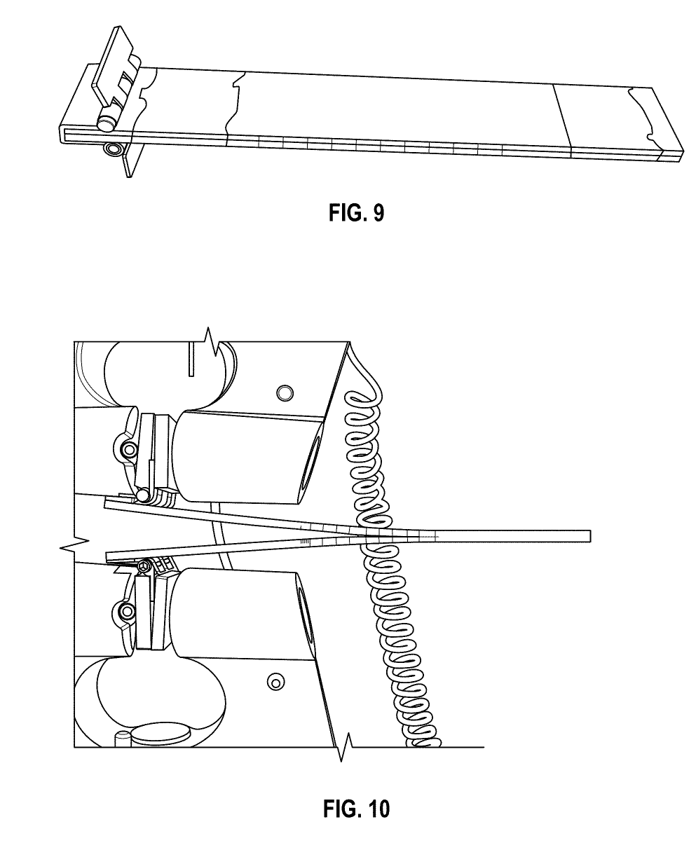

The material formed in Example 2-1 was combined together to produce a composite tested for self-healing in double cantilever beam (DCB) geometry. The specimen is shown in FIG. 9. Testing of the specimen is shown in FIG. 10. Note that this specimen was not created by automated fiber placement (AFP).

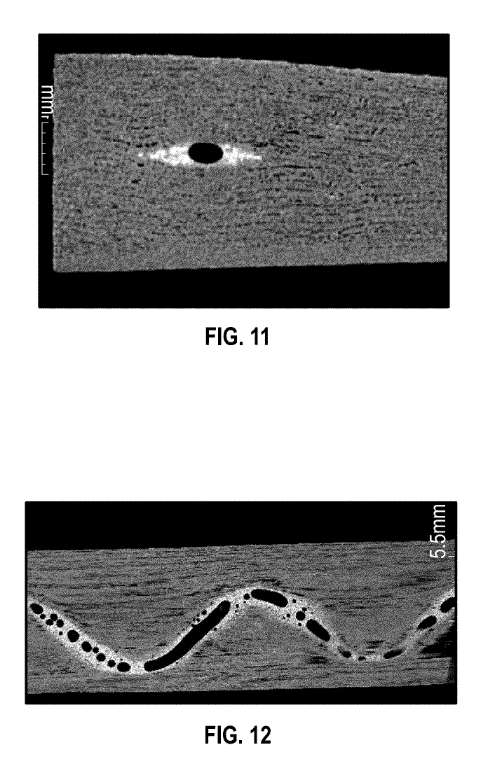

Up to 100% self-healing performance was shown via 3D-printing of polylactic acid sacrificial fiber onto carbon fiber prepreg. FIG. 11 illustrates micro-CT (computed tomography) images—basically x-ray images—showing that the channels are embedded, which enabled the self-healing. FIG. 12 illustrates a partially evacuated 3-D printed polylactic acid channel in a carbon fiber prepreg composite.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Additional Embodiments

The following exemplary embodiments are provided, the numbering of which is not to be construed as designating levels of importance:

Embodiment 1 provides a method of making a composite, the method comprising:

placing a resin-impregnated fiber on a tooling surface;

at least partially curing the resin-impregnated fiber; and

placing a material in contact with the resin-impregnated fiber, to provide the composite.

Embodiment 2 provides the method of Embodiment 1, wherein the material that is placed in contact with the resin-impregnated fiber is a sacrificial material.

Embodiment 3 provides the method of Embodiment 2, wherein the sacrificial material comprises a polymer comprising a repeating unit comprising a substituted or unsubstituted (C₂-C₂₀)hydrocarbylene and at least one of carbonate, carbamate, thiocarbonate, and thiocarbamate.

Embodiment 4 provides the method of any one of Embodiments 2-2, wherein the sacrificial material is a sacrificial fiber.

Embodiment 5 provides the method of any one of Embodiments 2-4, wherein the method is a method of making a cavitated composite, further comprising at least partially sacrificing the sacrificial material, to provide the cavitated composite.

Embodiment 6 provides the method of Embodiment 5, wherein sacrificing the sacrificial material comprises

exposing the composite material to at least one of heat, acid, base, and solvent, such that at least some of the sacrificial material degrades or dissolves; and

removing at least some of the degraded or dissolved sacrificial material, to form the cavitated composite.

Embodiment 7 provides the method of any one of Embodiments 1-6, wherein the resin-impregnated fiber is placed on the tooling surface before the material is placed in contact with the resin-impregnated fiber.

Embodiment 8 provides the method of any one of Embodiments 1-7, further comprising placing the material on the tooling surface prior to placing the resin-impregnated fiber on the tooling surface, wherein placing the material in contact with the resin-impregnated fiber comprises the placing of the resin-impregnated fiber on the tooling surface.

Embodiment 9 provides the method of any one of Embodiments 1-8, further comprising placing a second resin-impregnated fiber on top of the placed material, such that the placed material is between the resin-impregnated fiber and the second resin-impregnated fiber.

Embodiment 10 provides the method of any one of Embodiments 1-9, wherein the placing the resin-impregnated fiber on the tooling surface comprises unrolling the resin-impregnated fiber from a spool.

Embodiment 11 provides the method of any one of Embodiments 1-10, wherein the placing the resin-impregnated fiber on the tooling surface comprises unrolling the resin-impregnated fiber from a spool on an automated fiber placement machine and placing the resin-impregnated fiber on the tooling surface using a deposition head of the automated fiber placement machine.

Embodiment 12 provides the method of any one of Embodiments 1-11, wherein the placing the resin-impregnated fiber on the tooling surface comprises compressing the resin-impregnated fiber against the tooling surface.

Embodiment 13 provides the method of any one of Embodiments 1-12, wherein the at least partial curing of the resin-impregnated fiber occurs before the placing of the material in contact with the resin-impregnated fiber.

Embodiment 14 provides the method of any one of Embodiments 1-13, wherein the at least partial curing of the resin-impregnated fiber occurs during or after the placing of the material in contact with the resin-impregnated fiber.

Embodiment 15 provides the method of any one of Embodiments 1-14, further comprising heating the resin-impregnated fiber.

Embodiment 16 provides the method of any one of Embodiments 15, wherein the heating is performed at least partially prior to placing the resin-impregnated fiber on the tooling surface.

Embodiment 17 provides the method of any one of Embodiments 15-16, wherein the heating is performed at least partially after placing the resin-impregnated fiber on the tooling surface.

Embodiment 18 provides the method of any one of Embodiments 1-17, wherein the placing of the material in contact with the resin-impregnated fiber comprises at least one of extruding, spinning, and printing.

Embodiment 19 provides the method of any one of Embodiments 1-18, wherein the placing of the material in contact with the resin-impregnated fiber comprises 3D-printing the material in contact with the resin-impregnated fiber.

Embodiment 20 provides the method of any one of Embodiments 1-19, wherein the placing of the resin-impregnated fiber on the tooling surface and the placing of the material in contact with the resin-impregnated fiber are performed using the same machine.

Embodiment 21 provides the method of any one of Embodiments 1-20, wherein the placing of the resin-impregnated fiber on the tooling surface and the placing of the material in contact with the resin-impregnated fiber are performed using the same automatic fiber placement machine.

Embodiment 22 provides the method of any one of Embodiments 1-21, wherein the placing of the resin-impregnated fiber on the tooling surface is performed by an automatic fiber placement machine, and the placing of the material in contact with the resin-impregnated fiber is performed by 3D-printing using a 3D printer that is affixed to the automatic fiber placement machine.

Embodiment 23 provides the method of any one of Embodiments 1-22, wherein the resin impregnated fiber comprises carbon fiber prepreg.

Embodiment 24 provides a composite formed by the method of any one of Embodiments 1-23.

Embodiment 25 provides a cavitated composite formed by the method of any one of Embodiments 5-24.

Embodiment 26 provides a method of making a composite, the method comprising:

placing a web, tow, or tape of resin-impregnated fibers on a tooling surface using an automated fiber placement machine;

at least partially curing the resin-impregnated fibers; and

placing a material in contact with the resin-impregnated fibers using a 3D-printer that is affixed to the automated fiber placement machine, to provide a composite.

Embodiment 27 provides a method of making a composite, the method comprising:

placing a precursor composite material comprising a resin-impregnated fiber and a material on a tooling surface; and

at least partially curing the resin-impregnated fiber, to provide a composite.

Embodiment 28 provides the method of Embodiment 27, wherein the material is a sacrificial material.

Embodiment 29 provides the method of Embodiment 28, wherein the sacrificial material is a sacrificial fiber.

Embodiment 30 provides the method of any one of Embodiments 28-29, wherein the method is a method of making a cavitated composite, further comprising at least partially sacrificing the sacrificial material, to provide the cavitated composite.

Embodiment 31 provides the method of Embodiment 30, wherein sacrificing the sacrificial material comprises

exposing the composite material to at least one of heat, acid, base, and solvent, such that at least some of the sacrificial material degrade or dissolve; and

removing at least some of the degraded or dissolved sacrificial material, to form the cavitated composite.

Embodiment 32 provides the method of any one of Embodiments 28-31, wherein the sacrificial material comprises a polymer comprising a repeating unit comprising a substituted or unsubstituted (C₂-C₂₀)hydrocarbylene and at least one of carbonate, carbamate, thiocarbonate, and thiocarbamate.

Embodiment 33 provides the method of any one of Embodiments 27-32, wherein the material is embedded in the resin-impregnated fiber.

Embodiment 34 provides the method of any one of Embodiments 27-33, wherein the placing the precursor composite material on the tooling surface comprises placing a web, tow, or tape of resin-impregnated fibers comprising the resin-impregnated fiber on the tooling surface.

Embodiment 35 provides the method of any one of Embodiments 27-34, further comprising placing a second resin-impregnated fiber on top of the material, such that the material is between the resin-impregnated fiber and the second resin-impregnated fiber.

Embodiment 36 provides the method of any one of Embodiments 27-35, wherein the placing the precursor composite material on the tooling surface comprises unrolling the precursor composite material from a spool.

Embodiment 37 provides the method of any one of Embodiments 27-36, wherein the placing the precursor composite material on the tooling surface comprises unrolling the precursor composite material from a spool on an automated fiber placement machine.

Embodiment 38 provides the method of any one of Embodiments 27-37, wherein the placing the precursor composite material on the tooling surface comprises compressing the precursor composite material against the tooling surface.

Embodiment 39 provides the method of any one of Embodiments 27-38, further comprising heating the precursor composite material.

Embodiment 40 provides the method of Embodiment 39, wherein the heating is performed at least partially prior to placing the precursor composite material on the tooling surface.

Embodiment 41 provides the method of any one of Embodiments 39-40, wherein the heating is performed at least partially after placing the precursor composite material on the tooling surface.

Embodiment 42 provides the method of any one of Embodiments 27-41, wherein the resin impregnated fiber comprises carbon fiber prepreg.

Embodiment 43 provides a composite formed by the method of any one of Embodiments 27-42.

Embodiment 44 provides a cavitated composite formed by the method of any one of Embodiments 30-42.

Embodiment 45 provides a method of making a composite, the method comprising:

placing a resin-impregnated fiber on a tooling surface with an automated fiber placement machine;

placing a material in contact with the resin-impregnated fiber using a 3D-printer that is affixed to the automated fiber placement machine, to form a composite.

Embodiment 46 provides the method of Embodiment 45, wherein the material is a sacrificial material.

Embodiment 47 provides the method of any one of Embodiments 45-46, wherein the material is a sacrificial fiber.

Embodiment 48 provides an apparatus comprising:

an automated fiber placement machine configured to place a precursor composite material comprising a resin-impregnated fiber and a material on a tooling surface via a deposition head, and to at least partially cure the precursor composite to form a composite on the tooling surface.

Embodiment 49 provides the apparatus of Embodiment 48, wherein the material is a sacrificial material.

Embodiment 50 provides an apparatus comprising:

an automated fiber placement machine configured to place a resin-impregnated fiber on a tooling surface via a deposition head;

a 3D-printer affixed to the automated fiber placement machine that is configured to place a material in contact with the resin-impregnated fiber, to form a composite.

Embodiment 51 provides the method, apparatus, or composite of any one or any combination of Embodiments 1-50 optionally configured such that all elements or options recited are available to use or select from.

What is claimed is:

1. A method of making a composite, the method comprising:
placing a resin-impregnated fiber on a tooling surface;
at least partially curing the resin-impregnated fiber; and
placing a material in contact with the resin-impregnated fiber, to provide the composite.

2. The method of claim 1, wherein the material that is placed in contact with the resin-impregnated fiber is a sacrificial material.

3. The method of claim 2, wherein the sacrificial material comprises a polymer comprising a repeating unit comprising a substituted or unsubstituted (C₂-C₂₀)hydrocarbylene and at least one of carbonate, carbamate, thiocarbonate, and thiocarbamate.

4. The method of claim 2, wherein the method is a method of making a cavitated composite, further comprising at least partially sacrificing the sacrificial material, to provide the cavitated composite, wherein sacrificing the sacrificial material comprises:
exposing the composite material to at least one of heat, acid, base, and solvent, such that at least some of the sacrificial material degrades or dissolves; and
removing at least some of the degraded or dissolved sacrificial material, to form the cavitated composite.

5. The method of claim 1, further comprising placing the resin-impregnated fiber on the tooling surface before the material is placed in contact with the resin-impregnated fiber.

6. The method of claim 1, further comprising placing the material on the tooling surface prior to placing the resin-impregnated fiber on the tooling surface, wherein placing the material in contact with the resin-impregnated fiber comprises the placing of the resin-impregnated fiber on the tooling surface.

7. The method of claim 1, further comprising placing a second resin-impregnated fiber on top of the placed material, such that the placed material is between the resin-impregnated fiber and the second resin-impregnated fiber.

8. The method of claim 1, wherein the placing the resin-impregnated fiber on the tooling surface comprises unrolling the resin-impregnated fiber from a spool on an automated fiber placement machine and placing the resin-impregnated fiber on the tooling surface using a deposition head of the automated fiber placement machine.

9. The method of claim 1, wherein the at least partial curing of the resin-impregnated fiber occurs before the placing of the material in contact with the resin-impregnated fiber.

10. The method of claim 1, wherein the at least partial curing of the resin-impregnated fiber occurs during or after the placing of the material in contact with the resin-impregnated fiber.

11. The method of claim 1, wherein the placing of the material in contact with the resin-impregnated fiber comprises at least one of extruding, spinning, and printing.

12. The method of claim 1, wherein the placing of the material in contact with the resin-impregnated fiber comprises 3D-printing the material in contact with the resin-impregnated fiber.

13. The method of claim 1, wherein the placing of the resin-impregnated fiber on the tooling surface and the placing of the material in contact with the resin-impregnated fiber are performed using the same automatic fiber placement machine.

14. A composite formed by the method of claim 1.

15. The method of claim 1, wherein the method comprises:
placing a web, tow, or tape of a plurality of the resin-impregnated fibers on a tooling surface using an automated fiber placement machine;
at least partially curing the resin-impregnated fibers; and
placing the material in contact with the resin-impregnated fibers using a 3D-printer that is affixed to the automated fiber placement machine, to provide the composite.

16. A method of making a composite, the method comprising:
placing a precursor composite material comprising a resin-impregnated fiber and a material on a tooling surface; and
at least partially curing the resin-impregnated fiber, to provide a composite.

17. A composite formed by the method of claim 16.

18. A method of making a composite, the method comprising:
placing a resin-impregnated fiber on a tooling surface with an automated fiber placement machine;
placing a material in contact with the resin-impregnated fiber using a 3D-printer that is affixed to the automated fiber placement machine, to form a composite.

19. An apparatus for performing the method of claim 1, the apparatus comprising:
an automated fiber placement machine configured to place a precursor composite material comprising a resin-impregnated fiber and a material on a tooling surface via a deposition head, and to at least partially cure the precursor composite to form a composite on the tooling surface.

20. An apparatus for performing the method of claim 18, the apparatus comprising:
an automated fiber placement machine configured to place a resin-impregnated fiber on a tooling surface via a deposition head; and
a 3D-printer affixed to the automated fiber placement machine that is configured to place a material in contact with the resin-impregnated fiber, to form a composite.
